(19) United States
(12) Patent Application Publication
(10) Pub. No.: US 2021/0126932 A1
(43) Pub. Date: Apr. 29, 2021

(54) SYSTEM FOR TECHNOLOGY INFRASTRUCTURE ANALYSIS

(71) Applicant: SAPIEN CYBER LIMITED, Joondalup, Western Australia (AU)

(72) Inventors: Glenn Murray, Joondalup, Western Australia (AU); Kashup Vijay, Joondalup, Western Australia (AU); Joanne Irungu, Joondalup, Western Australia (AU); Will Reyes Nivia, Joondalup, Western Australia (AU); Tyson McElroy, Joondalup, Western Australia (AU)

(21) Appl. No.: 17/253,547

(22) PCT Filed: Jun. 20, 2019
(86) PCT No.: PCT/AU2019/050636

§ 371 Date: Dec. 17, 2020

(30) Foreign Application Priority Data
Jun. 20, 2018 (AU) 2018902189

(51) Int. Cl. H04L 29/06

(52) U.S. Cl. CPC H04L 63/1425; H04L 63/1433

(57) ABSTRACT

A system for identifying anomalies in Technology Infrastructure network, the network comprising a plurality of assets, comprising: receiver for receiving network traffic data, the network traffic data comprising collective signal outputs from a plurality of assets within the network; analyser for analysing the network data to identify anomalies in the signal outputs from the assets; means for providing the identified anomalies to at least one aggregation module, the aggregation module using the anomalies to identify faults in the Technology Infrastructure.

### FIELD OF INVENTION

The present invention relates to a system for technology infrastructure network analysis and, in particular, a system for identifying anomalies, incidents or attacks in Technology Infrastructure such as operational technology (OT) or information technology (IT) networks.

### BACKGROUND

The performance of OT networks is reliant on the correct operation of components within the ICS Supervisory Control and Data Acquisition (SCADA) Network. The OT network includes components including, but not limited to, program logic controllers (PLC), distributed control systems (DCS), actuators, sensors, switches, remote terminal units, master terminal units, human machine interfaces and data historians. Malfunction of these components can result in failure or malfunction of a system under control within the network. This can result in downtime of the network and in worst case scenarios catastrophic failure creating cost implications and potentially dangerous and/or fatal situations. Such events represent the significant risk to OT networks, especially those associated with critical infrastructure. The Australian Government's Security of Critical Infrastructure Bill 2017 seeks to address such risks associated with failure of critical infrastructure.

### SUMMARY OF INVENTION

Embodiments of the invention provides an Analytics System being a network Intrusion Detection System combined with Machine Learning that rapidly detects anomalies within network traffic to deliver actionable intelligence.

In a first aspect the invention provides a method for identifying anomalies in Technology Infrastructure network, the network comprising a plurality of assets, comprising the steps of: receiving network traffic data, the network traffic data comprising collective signal outputs from a plurality of assets within the network; analysing the collective signal output data to identify anomalies in signal outputs from the assets; providing the identified anomalies to at least one aggregation module, the aggregation module using anomalies in the network data to identify faults in the technology infrastructure. Embodiments of the invention identify suspicious activity in the operating system.

Embodiments further comprise the steps of: directing the network traffic data to provide multiple streams of the collective signal output data; and, transmitting a steam of the collective signal output data to an analysing module for analysis.

In embodiments the system comprises multiple analysing modules and a stream of the collective signal output data is transmitted to each of the multiple analysing modules. The stream of data is customised to only deliver vital data for further analysis and therefore reduce the processing time for each stream. In embodiments the customised stream of data is filtered.

In embodiments the step of analysing the collective output signal is performed in parallel at each of the multiple analysing modules. Parallel data processing is achieved through complex time synchronisation to allow alerts to be correlated at a latter processing phase.

Embodiments include the further step of correlating outputs from the analysed signals to generate alerts.

In embodiments the multiple analysing modules use different data extraction techniques. Each parallel system is performing a unique method of data analysis that will allow for greater reliability and accuracy of result when combined.

In embodiments an analysing module comprises an inventory extraction module, the inventory extraction module performing the step of analysing the network output data to identify data signatures of assets and using the identified data signatures to construct an inventory of assets within the network.

In embodiments an analysing module comprises an intrusion detection module, the intrusion detection module performing the steps of: Receiving threat data associated with identified assets, the threat data comprising data associated with known attacks on identified assets; determining whether the identified assets exist in the network; identifying retrieved threat data for assets that exist in the network.

Embodiments comprise the further step of comparing the network traffic data with identified retrieved threat data to detect anomalies in the network.

In embodiments the step of comparing is performed by at least one sensor or algorithm.

In embodiments the sensors or algorithms compare the data in parallel. This step improves the false positive rate and reduces the number of alerts being generated to prevent overloading the user with excessive alerts

In embodiments the sensors use rule sets associated with known attacks. These rules are customised and combined in a way to improve the accuracy of detection.

Embodiments comprise the steps of: retrieving a system log, the system log identifying typical signal data for assets; analysing the collective output signal to determine whether signals relate to typical signal data of the assets.

Embodiments further comprise the steps of retrieving known malware data signatures and analysing the collective data signal to identify signatures associated with known malware.

In embodiments the step of analysing is performed at the edge of the network with nanosecond precision which is maintained through all processes.

In embodiments data relating to the identified anomalies is transmitted from the network to an operations centre.

In embodiments the data is transmitted across a communication network.

Embodiments comprise the further step of receiving data relating to identified anomalies at an operations centre, the data identifying the network in which the anomaly is identified.

In embodiments the operations centre receives data from multiple networks.

Embodiments comprise the step of analysing the received data relating to identified anomalies and providing information comprising at least one of: threat intelligence, network assessment, incident reporting, advice on how to address vulnerabilities, threats and/or breaches identified on the network.

Embodiments includes a Vulnerability Management Service which provides a unique approach to managing software vulnerabilities within technology infrastructure. This system determines software vulnerability patching priorities for a customer which are calculated automatically based on risk. The results of the automatic risk assessment produced by the system allow a customer to selectively carry out software patch updates and therefore reduce overall risk to their network at an optimal cost to their business.

The Vulnerability Management Service include an Alerting sub-system and a Work List Sub System. The Alerting sub-system calculates the effect of a vulnerability within the context of the Asset Systems. This is achieved by assessing Asset System Inventory, Risk Rating and Access Vectors. This assessment determines the pathways to a vulnerable devise and criticality of the devices. Vulnerability descriptions from external sources are used to determine the severity and nature of a security exploit and the system finally reports if software update is required reduce the risk to the customer.

In a further aspect the invention provides a system for identifying anomalies in Technology Infrastructure networks, the network comprising a plurality of assets, comprising: Receiver (Acquisition Sensor) for receiving network traffic data, the network traffic data comprising collective signal outputs from a plurality of assets within the network; Analyser (Control System) for analysing the collective signal output data to identify anomalies in the signal output data from the assets; Means for providing the identified anomalies to at least one aggregation module, the aggregation module using anomalies in the network data to identify faults in the Technology Infrastructure.

Further embodiments include Manager (Command Centre) for managing the system and providing the user interfaces. Further embodiments include Means for providing access to data visualizations and data interrogation tools within the system. Further embodiments include Central Analysis (Security Operations) for providing access to multiple systems data within a single user interface, accessible remotely by secure privilege access.

In embodiments the network data comprises the combination of signal outputs from a plurality of assets within the network.

Further embodiments comprise: Means for directing the network traffic data to create multiple streams of the collective signal output data; and, Transmitter for transmitting a stream of the collective signal output data to an analysing module for analysis.

In embodiments the system comprises multiple analysing modules and a stream of the collective signal output data is transmitted to each of the multiple analysing modules. The stream of data is customised to only deliver vital data for further analysis and therefore reduce the processing time for each stream.

In embodiments the step of analysing the collective output signal is performed in parallel at each of the multiple analysing modules. Parallel data processing is achieved through complex time synchronisation to allow alerts to be correlated at a latter processing phase.

In embodiments the multiple analysing modules use different data extraction techniques.

In embodiments an analysing module comprises an inventory extraction module, the inventory extraction module performing the step of analysing the network output data to identify data signatures of assets and using the identified data signatures to construct an inventory of assets within the network.

In embodiments an analysing module comprises an intrusion detection module, the intrusion detection module comprising: Receiver for receiving threat data associated with identified assets, the threat data comprising data associated with known attacks on identified assets; Means for determining whether the identified assets exist in the network; Means for identifying retrieved threat data for assets that exist in the network.

Further embodiments comprise means for comparing the network traffic data with identified retrieved threat data to detect anomalies in the network.

In further embodiments the means for comparing is a sensor or an algorithm.

In embodiments the sensors or algorithms compare the data in parallel. This step improves the false positive rate and reduces the number of alerts being generated to prevent overloading the user with excessive alerts

In embodiments the sensors use rule sets associated with known attacks. These rules are customised and combined in a way to improve the accuracy of detection.

Further embodiments comprise: Means for retrieving a system log, the system log identifying typical signal data for assets; Means for analysing the collective output signal to determine whether signals relate to typical signal data of the assets.

Further embodiments comprise means for retrieving known malware data signatures and analysing the collective data signal to identify signatures associated with known malware.

In embodiments the step of analysing is performed at the edge of the network with nanosecond precision which is maintained through all processes.

In embodiments data relating to the identified anomalies is transmitted from the OT network to an operations centre.

In embodiments the data is transmitted across a communication network.

Further embodiments comprise means for receiving data relating to identified anomalies at an operations centre, the data identifying the network in which the anomaly is identified.

In embodiments the operations centre receives data from multiple networks.

Further embodiments comprise means for analysing the received data relating to identified anomalies and providing information comprising at least one of: threat intelligence, network assessment, incident reporting, advice on how to address vulnerabilities, threats and/or breaches identified on the network.

Embodiments includes a Vulnerability Management Service which provides a unique approach to managing software vulnerabilities within technology infrastructure. This system determines software vulnerability patching priorities for a customer which are calculated automatically based on risk. The results of the automatic risk assessment produced by the system allow a customer to selectively carry out software patch updates and therefore reduce overall risk to their network at an optimal cost to their business.

The Vulnerability Management Service include an Alerting sub-system and a Work List Sub System. The Alerting sub-system calculates the effect of a vulnerability within the context of the Asset Systems. This is achieved by assessing Asset System Inventory, Risk Rating and Access Vectors. This assessment determines the pathways to a vulnerable devise and criticality of the devices. Vulnerability descriptions from external sources are used to determine the severity and nature of a security exploit and the system finally reports if software update is required reduce the risk to the customer.

In a third aspect the invention provides a method for identifying anomalies in an operational technology (OT) network, the network comprising a plurality of assets, comprising the steps of: receiving network traffic data, the network traffic data comprising collective signal outputs from a plurality of assets within the OT network; analysing the collective signal output data to identify anomalies in the network data; providing the identified anomalies to at least one aggregation module, the aggregation module using anomalies in the network data to identify faults in the operating system.

In embodiments the network data comprises the combination of signal outputs from a plurality of assets within the OT network.

A system for identifying anomalies in an operational technology (OT) network, the network comprising a plurality of assets, comprising: Receiver for receiving network traffic data, the network traffic data comprising collective signal outputs from a plurality of assets within the OT network; Analyser for analysing the collective signal output data to identify anomalies in the network data; Means for providing the identified anomalies to at least one aggregation module, the aggregation module using anomalies in the network data to identify faults in the operating system.

In embodiments the network data comprises the combination of signal outputs from a plurality of assets within the OT network.

### BRIEF DESCRIPTION OF THE DRAWINGS

An embodiment of the invention is now described with reference to the following drawings in which:

FIG. 1 shows architecture for a first embodiment of the invention.

FIG. 2 shows components within the analytics system.

FIG. 3 shows architecture for a network including multiple sites.

FIG. 4 shows components for the parallel stream processing.

### DETAILED DESCRIPTION

Embodiments of the present invention relate to a method for identifying anomalies within Technology Infrastructure including, for example, the Industrial Control System (ICS) of an Operational Technology (OT) network. In the examples described below an embodiment of the system is described in relation to an OT network. Further embodiments of the invention are implemented in information technology (IT) networks

The ICS comprises a plurality of assets, typically grouped into pneumatic, hydraulic and electrical devices including program logic controllers (PLC), distributed control systems (DCS), actuators, sensors, switches, remote terminal units, master terminal units, human machine interfaces and data historians. Many of the assets within the network control operational devices. Such OT networks include oil and gas plants, utilities, mining, telecommunication and power stations. These types of infrastructure include hundreds of thousands of field devices.

Typically, the field devices are electronic components. Failure of some of these components can lead to damage to the infrastructure and long downtimes while systems are repaired, or components are replaced. In extreme cases, failure of components can lead to catastrophic events, including explosions or shutdown of entire sites. Field device malfunction may be caused by electrical, pneumatic and mechanical component failure initiated by a cyber-attack. By monitoring the network data communications of the OT and identifying anomalies, incidents and attacks, the embodiments of the invention help protect technology infrastructure.

Embodiments of the invention receive OT network traffic data where the OT network traffic data includes collective signal outputs from multiple assets within the OT network. Embodiments analyse the collective signal output to identify anomalies in the network traffic.

In embodiments information and recommendations relating to the identified anomalies is provided to designated parties in real time to allow assessment of the OT network. This actionable intelligence allows operations to manage ongoing maintenance and ongoing performance of the OT network.

In further embodiments anomaly data from multiple OT networks, for example at different sites, is provided to a central analysis system (Security Operations). The central analysis system can determine whether anomalies identified in one OT network may be relevant to others, for example if a particular type of component is malfunctioning on one site, the same component may be malfunctioning or may be likely to malfunction at some time in the future. Such information may then be provided to management of other OT networks and used in ongoing network analysis.

In embodiments systems are being monitored constantly to detect anomalies. This allows operational problems in the OT network to be detected quickly and risk mitigation and resolution to be undertaken in near real time.

In embodiments of the invention the analysis of the collective signal output is performed at the edge of the OT network. Typically, this is performed on site at the OT network within the wired infrastructure and within security firewalls. The benefit of performing analysis at the edge is that the large data outputs (including terabytes of data) are not required to be transmitted over communication networks before being analysed (i.e. processed at the edge). Transmission of such large data can introduce transmission latency and can also result in errors in data transmission and reception.

Analysis of the signal data may be performed within the OT network and any identified anomalies may be transmitted to remote locations for review and mitigation plans. The anomaly data transmitted across communication networks to remote locations is small in size (for example megabytes). Consequently, these data files may be transmitted quickly across the communication networks, including wireless communication networks. Realtime transmission of anomaly data allows the anomaly data to be analysed off site in real time. This allows site managers and other staff responsible for operation of the site to be alerted to anomalies quickly.

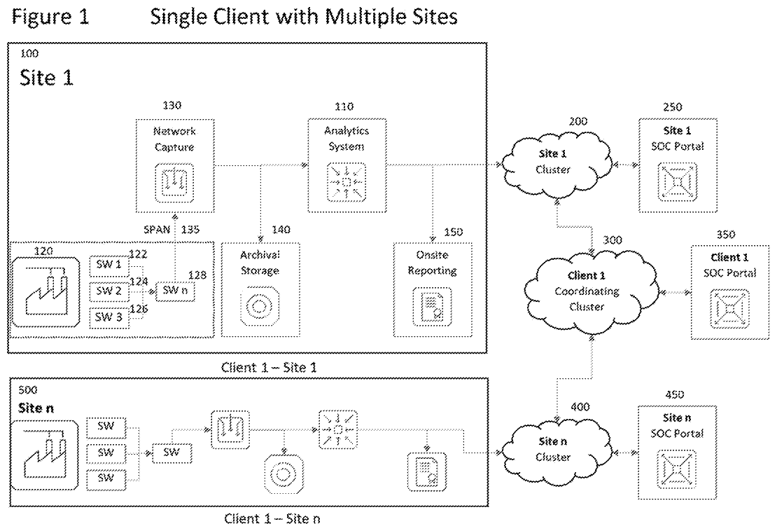

FIG. 1 shows a high-level architectural implementation of an embodiment of the system. The example of FIG. 1 includes a single client with multiple sites. Site 100 is an oil and gas processing plant (i.e. a critical infrastructure site) having an incorporated the Analytics System 110 and Network Capture 130.

In FIG. 1 the OT network for the oil and gas processing plant is shown at 120. Oil and gas processing plant includes a number of network switches 122, 124, 126, 128 and other field devices, for example those devices mentioned above, which control the operation of the oil and gas plant. The field devices control critical devices within the oil and gas plant including, gas compressors, fin fans, generators, pumps and other devices.

Each of the electrical components generates network traffic data. The data signals represent the state of the electrical components along with other information about the operation of the component at that time. The data traffic is made up from different protocols from different manufacturers, including Siemens, Honeywell, Schneider Electric, Yokogawa, General Electric, Cisco, Huawei. The content of the data signals includes the state of the device, for example a switch or other electrical component, the IP address or MAC address of the device, data transmitted by the device, the IP address or MAC address of the destination device which the device is communicating with, time stamp details for the data identifying the time for data transmission. Further data may be included in the signal data from the device.

The Operational Technology network for the oil and gas plant 120 including all field devices concerned with operation of the oil and gas plant are contained within network 120.

The collective signal outputs from all field devices within operational technology network 120 are combined into a single stream using a Packet Capture (PCAP) device and routed to network capture device 130. In the example of FIG. 1 these are routed across SPAN connection 135.

The monitoring point in the network at which data traffic is collected can be selected based on network structure. The data is captured without interruption of the operation of the OT network.

After signal data is collected and collated at network capture processor 130 it is forwarded to onsite archival storage 140. Archival storage 140 retains a local copy of encrypted compressed PCAP data for any future forensics work signal data from OT network 120.

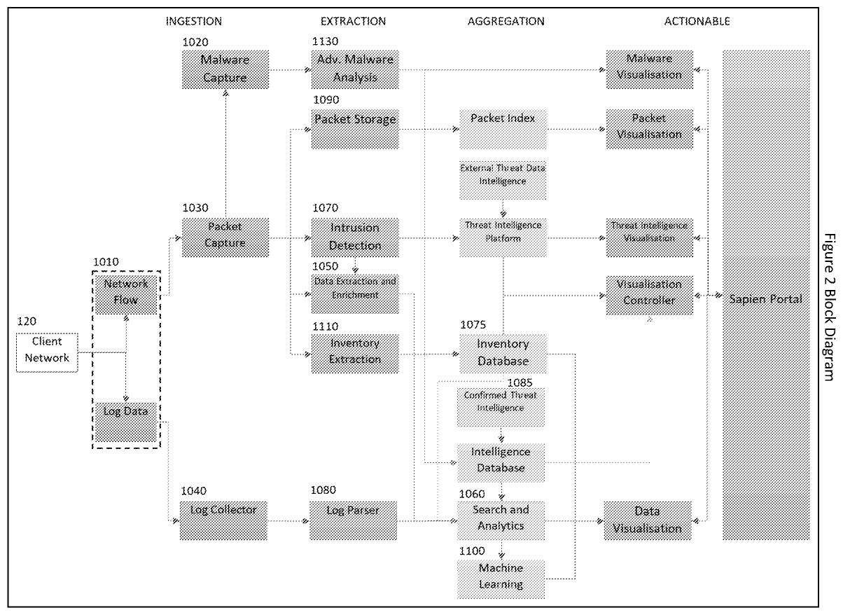

The captured PCAP network traffic is also passed to Analytics System 110. Analytics System 110 is described in detail below with respect to FIG. 2a. Analytics System 110 receives signal data stream from OT network 120 and processes the signal data stream to identify anomalies within OT network 120.

Analytics System 110 performs a number of analyses on the signal data. The data is copied and directed to multiple sensors in parallel. Processing network packet data in parallel allows multiple network interfaces to be handled simultaneously. Packet headers are analysed, tracked and key data stored without overloading the available memory. The system can perform at very high speeds, for example up to Gbps.

The dissimilar nature of each sensor improves the accuracy of threat detection. Each sensor extracts different features of network traffic that present threat signatures.

The sensors are different and conduct different analysis on the signals. The aggregated outputs from the sensors enable threats to be identified more reliably and helps to reduce false positives. The outputs from the sensors are correlated and aggregated. Similarities of the data are identified by merging the data to identify signatures of attacks or other anomalous behaviour within the OT network.

In embodiments, the system filters out all unnecessary network traffic centrally and only distributes key network packet data to each sensor.

Analytics System 110 identifies signatures within the OT network data indicative of attack and/or anomalies in the performance of the OT network. Analytics System 110 also processes data to extract the inventory of OT field devices within OT network 120. Analytics System 110 also processes captured PCAP data to identify presence of any malware within OT network.

Analytics System 110 is located on site with the OT network. Typically, this allows the Analytics System to be connected to OT network via high capacity hardwired data connections, for example ethernet connections. Data output from network capture 130 includes gigabytes of data per day. By positioning the Analytics Systems on site and providing hardwired connections to the platforms, data can be transferred to Analytics System in real time across the high capacity network cabling avoiding latency and errors in data transmission and analysis.

Depending on activity within the OT network data output can vary from time to time. Embodiments of the system deal with the inconsistent volumes of data being transmitted throughout the network. The system manages memory and processing power to cater for variations in network traffic volumes.

Output from Analytics System 110 allows functionality of onsite reporting 150 if required. Importantly, embodiments of the invention enable the large data sets associated with OT devices from the critical infrastructure to be analysed onsite in real time. The system is able to manage both variations in size of dataset and speed of dataset and is optimised to ensure processing performance does not deteriorate due to these variations. This ensures that all devices are identified in near real time allowing for analysis, tracking and data storage to be synchronized with any alert data that is generated.

Embodiments of the invention enable visual representation of the network to be presented illustrating connections between devices and common signatures of devices using information retrieved from the stored data.

The embodiment of FIG. 1 is an example in which a client has multiple OT network sites (100, 500). Client site 500 includes equivalent analysis and reporting components associated with the infrastructure of site 500.

In an embodiment of FIG. 1 the processed data and anomaly identification and information is transmitted from Site 1 (100) to a Site 1 Cluster (200). In the embodiment of FIG. 1 the site 1 cluster 200 is at the edge of the encrypted site network across a communications network. The output from Analytics System 110 is provided to site 1 cluster in near real time.

Typically, output from Analytics System 110 only contains encrypted dashboard information associated with cluster site 100. Data at Site 1 cluster 200 can be viewed on mobile or desktop devices. Typical data files from system to Site 1 cluster may have a size of order megabytes.

Actionable intelligence from Analytics System 110 is available at site 1 SOC Portal 250. This portal can be monitored to allow the current status of Site 1 to be assessed and managed.

Client Site n 500 represents an equivalent remote oil and gas site and Site n SOC Portal 450 which interfaces with Site n cluster 400.

For a company or body having responsibility for multiple sites 100, 500 output from multiple sites can be collated and provided to Client Coordinating Cluster 300. Client co-ordinating cluster 300 receives input from Site 1 cluster and Site n cluster and interfaces with client 1 SOC portal 350. Examples of personnel who may be responsible for monitoring or managing multiple sites may be for example Chief Information Security Officer (CISO).

In the example of FIG. 1, all data transmitted from Site 1 is encrypted dashboard visualisation data only. FIG. 2 is a functional block diagram of the Network Capture 130, Analytics System 110, Archival Storage 140 and Onsite Reporting 150 from FIG. 1 and shows outbound communication to the SOCs.

As also shown in FIG. 1 the collective data output is routed into Analytics System 110 from the Network Capture 130. The components of the Analytics System (110, 130, 140, 150) are shown in more detail in FIG. 2. The input signal from Client Site 1 (120) is received at 1010. For live operations, the data input signal is the collective signal output from the OT network 120 captured in real time. For static investigations, the data is live streamed from the OT network 12o to a temporary storage device for a finite period of time. The captured network data is then replayed from the data storage device, for example a hard disk drive storage device.

The size of data varies from site to site based on the number of devices and speed of the network communications. The network data stream input 1010 is captured and pre-processing is conducted. Pre-processing may include indexing data, time stamping data or other data manipulation techniques to allow for downstream processing. In this phase data is then provided to three main processing components: packet capture 1030, Malware Capture and Log Collector 1040.

During extraction, data that has been pre-processed from the ingestion phase is passed through various sensors and algorithms and is initially assessed against intelligence to detect known malfunctions which may be provided from any site within the system. Unknown threats and anomalies can also be identified by analysing data and identifying anomalies in that data using machine learning and artificial intelligence methods.

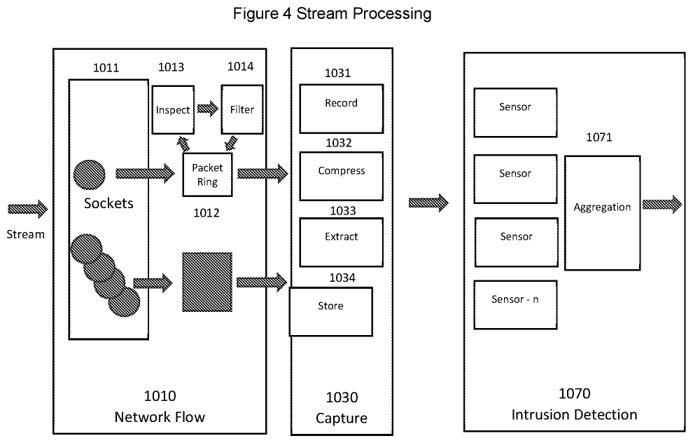

FIG. 4 details the network data stream process in which network data is ingested and processed (also shown in components 1010 1030 1070 of FIG. 2). The embodiments within the system process network data in parallel to allow multiple network interfaces to be managed simultaneously. The system manages memory usage and processing power to cater for variations in network traffic volumes and maintain data synchronisation throughout all the elements of the system.

Within Network Flow 1010 the network traffic is copied to various sockets for inspection. This inspection occurs in a Packet Ring 1012 which processes the data through the Inspect 1013 process and Filter 1014 process and then stores the results before moving to the Capture 1030 process. Several processes are performed in the Capture 1030 element to prepare the data for sensor interrogation by the sensors. This includes mechanisms to Record 1031, Compress 1032, Extract 1033 and Store 1034 the key data elements. In particular the data is customised dependent on the type of sensor. For example, data may be filtered. Data streams routed to different sensors may include different forms of the data set due to different customisations. This process helps reduce processing time for each data stream. Different sensors use different data extraction techniques.

The Intrusion Detection 1070 element processes network data in parallel through a number of sensors. Parallel analysis is achieved through time synchronisation. Time synchronisation of data through the various sensors enables data to be collated and aggregated after analysis.

The system takes the results from the combination of multiple sensors and performs Aggregation 1071. This reduces the false positive rate and increases the accuracy of detected anomalies. This combination of Sensors, including machine learning, improve the reliability of the achieving an accurate detection and therefore provide a mechanism to produce a reliable threat status. Sensors use rule sets associated with known attacks to identify presence of known attacks within the OT network.

Pre-processed data is transmitted simultaneously from 1) Packet Capture module 1030 to the 1090 Packet Storage, 1070 Intrusion Detection, 1050 Data Extraction and Enrichment, 1110 Inventory Extraction; 2) Malware Capture 1020 to 1130 Advanced Malware Analysis and 3) Log Collector 1040 to Log Parser 1080. As discussed above, module 1070 is a system of system of multiple sensors that automatically detect the known known anomalies and cyber-attacks. Module 1070 is used to interrogate the network traffic matching anomaly and known cyber-attack signatures. Modules 1010, 1030 and 1070 are show in more detail in FIG. 2a.

Modules 1080 and 1090 provide the necessary tool set to allow data analyst to conduct further investigation of the network traffic to identify and respond to the known unknown anomaly or cyber-attack.

Machine learning module 1100 is a combination of multiple algorithms. Module 1100 is used to further enhance the detection of anomalies and cyber-attacks, in particular module 1100 is used to identify patterns in the data which relate to unknown unknowns. The Machine Learning process is performed by four distinct elements. Data handling is interrogating the network data stream before Pre-Processing is carried out to transform the data based on the data stream features. The machine learning model is built after these two activities to train the system on the behaviours being identified. Finally, classification is conducted to rank the results and determine if alert thresholds have been breached to cause alerts to be generated.

Inventory extraction module 1110 processes the collective data to identify data associated with on-site field devices. Complex protocol analysis is used to extract the information of the device from OSI model layer 2 network traffic to identify and confirm the inventory of field devices on the site. Output from the inventory extraction module is provided to the inventory data base 1075. The output of the inventory database is provided to Search and Analytics 1060. This data is used to identify devices within the OT network and to create a map of connections between devices, thus creating a mapping of devices within the OT network. Typically, inventory extraction module analyses the network data to identify data signatures of devices and construct the inventory of devices within the OT network.

Rule sets within module 1070 Intrusion Detection System, are associated with signatures of anomalies and cyber-attacks. If a signature within the network traffic on a field device which is in the OT network inventory matches a signature associated with an anomaly or cyber-attack from module 1070, then the system makes a correlation that the field device in the OT network has an anomaly or a cyber-attack has occurred. Typically, this method identifies Common Vulnerability Exposures (known knowns).

Analytics System 110 provides information output to multiple potential receivers. The output from analysis platform 110 includes identified threat intelligence, for example when malfunction of a switch or other field device has been detected within OT network 120.

Analytics System 110 output can be programmed to be triggered under different circumstances. For example, in a first embodiment output data may only be transmitted when an anomaly or cyber-attack has been detected within OT network 120.

In further embodiments outputs may be automatically generated periodically to confirm the status of OT network 120. For example, whether to confirm that no anomalies or cyber-attacks have been detected.

Notifications for Site 1 (100) may also be sent to external Site Security Operation Centres (SOC) 250. Notifications applicable to multiple sites that are operated by a single client responsible for all sites may be sent to external Client SOC 350. Such SOCs are remote from site 100 and information and notifications are transmitted to the security operation centres across communication networks. The SOC user interface portal is customisable for each client which can be accessed on a fixed or mobile device. The portal will provide the customer with information from the Analytics System 110 including:
threat intelligence,
network assessment,
inventory assessment,
recommendations on how to address anomaly or cyber-attack,
anomalies and/or cyber-attacks identified on the network.

Remote analysis of the notifications and actionable intelligence allows offsite personnel to monitor performance of site 100. This includes identifying threats and producing mitigation or resolution actions that can be communicated directly back to SOC portal 250. This remote analysis and monitoring of the site also allows third party security companies to monitor the sites.

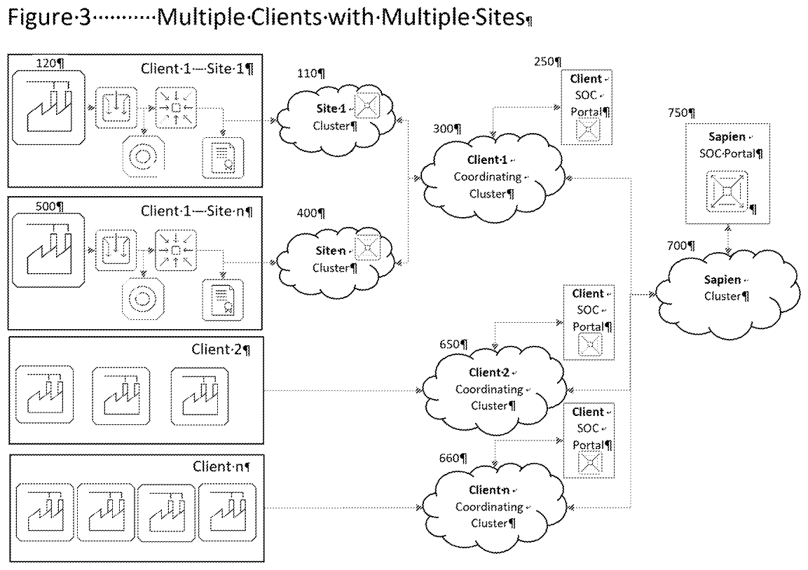

FIG. 1 illustrate embodiments in which a particular client monitors multiple sites 100 through to site n 500. FIG. 3 illustrate embodiments in which multiple clients 300, 650 and 660 each monitor multiple sites. In the example of FIG. 1 each site has a designated cluster 200, 400 and a designated security operation centre portal 250, 450. Typically, site management would be provided access to the security operation centre portals 250, 450. Additionally, as discussed above, a client will have a central coordination security operation centre portal 350 for monitoring all its sites.

In the example of FIG. 1, coordinating cluster 300 is provided with actionable intelligence from sites 100 and 500 from clusters 200 and 400. This information can be provided to a Chief Information Security Officer (CISO) or other suitable personnel. This information transfer provides a client security operation centre 350 with actionable intelligence related to all sites for which the client owns or is responsible. Such embodiments provide the advantage that a client (for example the Chief Information Security Officer) is provided with a central view of all sites.

Further embodiments include multiple clients and each with multiple sites shown in FIG. 3. This centralised view of multiple sites delivers significant advantages that allow clients to determine whether attacks or anomalies in one site may be relevant to other sites.

Client SOC portal 350 may notify sites of malfunctions identified in other sites. This information is provided back to Analytics System 110 confirmed threat intelligence module 1085 and Search and Analytics module 1060. These modules interact to identify whether any known anomalies and/or attacks identified in other sites within the network are present on the current site. By distributing anonymous threat intelligence in this way provides an opportunity to detect known anomalies and attacks efficiently for all clients.

The embodiment of FIG. 3 includes a further level of overview of the OT network infrastructure. In the embodiment of FIG. 3 a central cluster 700 includes input from multiple client coordinated clusters 300, 650, 660. Actionable intelligence is provided to a central security operation centre portal 750. Such infrastructure design enables performance of sites from different clients to be analysed and compared. Again, the advantage of having broader oversight of the performance of OT network sites is that exposure to a greater number of threats, anomalies, sites and field devices is provided. Such analysis enables determination of whether a malfunction at one site would be relevant to other sites within the architectural network. This includes information related to threat intelligence, network assessment, incident reporting and advice on vulnerabilities, etc. This is provided from central security operations centre portal 750 back into the specific site analytics systems 110 to aid or pre-empt identification of malfunctions within those sites.

The interactions between different sites and the availability of data enable device and system anomalies to be identified. Overall, the system delivers an ongoing feedback loop into the onsite analytics systems 110. This ongoing feedback allows an update of risk and identified threats and anomalies to be provided throughout the wider network.

The communication of the known unknown anomaly within the wireless site network, in particular by the client co-ordinating clusters and portals, allows comparison of those identified anomalies which have not yet been attributed to a specific malfunction (known unknowns). The network continues to evolve by analysing those anomalies in order to identify which component they relate to. Machine learning and artificial intelligence is also used to further enhance the detection of anomalies when a signal that has not yet been identified as an anomaly (unknown unknowns).

Embodiments of the invention provide a method for protecting critical infrastructure by identifying threats and anomalies in the OT network. Such systems improve cyber security by analysing large component output data signals on site in real time

Embodiments allow identification of current infrastructure for inventory purposes and identify attacks and anomalies in data which can be used to track performance of field devices onsite. Onsite analysis enables reporting of attacks anomalies and malfunctions to be provided in near real time to remote security operation centres. Since encrypted dashboard data is transmitted these relatively small data sets can be transmitted in near real time. Offsite analysis can then be conducted and reported back to the site for action.

Multiple site clusters provide an opportunity for real time review and management of multiple sites and provide the great benefit of larger data sets and experience. This is particularly important in cyber-attacks which may attack multiple sites simultaneously or sequentially. Analysis of multiple sites provides the additional advantage that machine learning and artificial intelligence improves when larger data sets are analysed. The real time identification of performance of different sites enables real time decisions to be made affecting the performance of the sites and real time decisions to be taken upon action.

Embodiments include a Vulnerability Management Service which manages software vulnerabilities within technology infrastructure. This system determines software vulnerability patching priorities for a customer which are calculated automatically based on risk. The results of the automatic risk assessment produced by the system allow operators to selectively carry out software patch updates and therefore reduce overall risk to the network.

The Vulnerability Management Service include an Alerting sub-system and a Work List Sub System. The Alerting sub-system calculates the effect of a vulnerability within the context of the Asset Systems. This is achieved by assessing Asset System Inventory, Risk Rating and Access Vectors. This assessment determines the pathways to a vulnerable devise and criticality of the devices. Vulnerability descriptions from external sources are used to determine the severity and nature of a security exploit and the system finally reports if software update is required reduce the risk to the network.

By retaining copies of all data embodiments of the invention allow analysis to be performed on data using deep packet inspection after a threat has been detected. This can enable data packets to be analysed, for example at a particular time, to identify the origin of a threat, for example from a location, device etc.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for identifying anomalies in a technology infrastructure network, the network comprising a plurality of assets, comprising the steps of:
receiving network traffic data, the network traffic data comprising collective signal outputs from a plurality of assets within the network;
analysing the network data to identify anomalies in signal outputs from the assets;
providing the identified anomalies to at least one aggregation module, the aggregation module using the anomalies to identify faults in the Technology Infrastructure.

2. The method according to claim 1 further comprising the steps of:
directing the network traffic data to create multiple streams of the network traffic data; and
transmitting a stream of the network traffic data to an analysing module for analysis.

3. The method according to claim 1 wherein the system comprises multiple analysing modules and network traffic data is transmitted to each of the multiple analysing modules

4. The method according to claim 3 comprising the step of filtering the network traffic data transmitted to an analysing module.

5. (canceled)

6. The method according to claim 2 wherein the step of analysing the collective output signal is performed in parallel at each of the multiple analysing modules.

7. The method according to claim 6 wherein the step of performing the analysing in parallel is achieved through time synchronisation.

8. (canceled)

9. The method according to claim 3 wherein the multiple analysing modules use different data extraction techniques.

10. The method according to claim 1 wherein an analysing module comprises an inventory extraction module, the inventory extraction module performing the step of analysing the network output data to identify data signatures of assets and using the identified data signatures to construct an inventory of assets within the network.

11. The method according to claim 1 wherein an analysing module comprises an intrusion detection module, the intrusion detection module performing the steps of:
receiving threat data associated with identified assets, the threat data comprising data associated with known attacks on identified assets;
determining whether the identified assets exist in the network;
identifying retrieved threat data for assets that exist in the network.

12.-23. (canceled)

24. The method according to claim 1 comprising the step of analysing the received data relating to identified anomalies and providing information comprising at least one of:
threat intelligence, network assessment, incident reporting, advice on how to address vulnerabilities, threats and/or breaches identified on the network.

25. A system for identifying anomalies in technology infrastructure network, the network comprising a plurality of assets, comprising:
a receiver for receiving network traffic data, the network traffic data comprising collective signal outputs from a plurality of assets within the network;
an analyser for analysing the network data to identify anomalies in the signal outputs from the assets;
means for providing the identified anomalies to at least one aggregation module, the aggregation module using the anomalies to identify faults in the Technology Infrastructure.

26. The system according to claim 25 further comprising:
means for reproducing the network traffic data to create multiple copies of the network traffic data; and,
a transmitter for transmitting a stream of network traffic data to an analysing module for analysis.

27. The system according to claim 25 wherein the system comprises multiple analysing modules and a stream of the network data is transmitted to each of the multiple analysing modules.

28. The system according to claim 25 comprising a filter to filter the data transmitted to each of the multiple analysing modules.

29. (canceled)

30. The system according to claim 25 wherein the multiple analysing modules are arranged in parallel.

31. The system according to claim 30 wherein the data is processed in parallel using complex time synchronisation to allow alerts to be correlated at a latter processing phase.

32. The system according to claim 27 wherein the multiple analysing modules use different data extraction techniques.

33. The system according to claim 27 wherein an analysing module comprises an inventory extraction module, the inventory extraction module performing the step of analysing the network output data to identify data signatures of assets and using the identified data signatures to construct an inventory of assets within the network.

34.-39. (canceled)

40. The system according to claim 25 further comprising:
means for retrieving a system log, the system log identifying typical signal data for assets;
means for analysing the collective output signal to determine whether signals relate to typical signal data of the assets.

41.-46. (canceled)

47. The system according to claim 25 further comprising means for analysing the received data relating to identified anomalies and providing information comprising at least one of:
threat intelligence, network assessment, incident reporting, advice on how to address vulnerabilities, threats and/or breaches identified on the network.
